(19) United States
(12) Patent Application Publication
(10) Pub. No.: US 2021/0180162 A1
(43) Pub. Date: Jun. 17, 2021

(54) HIGH HARD PHASE FRACTION NON-MAGNETIC ALLOYS

(71) Applicant: Oerlikon Metco (US) Inc., Westbury, NY (US)

(72) Inventors: James Nathaniel Vecchio, San Diego, CA (US); Justin Lee Cheney, Encinitas, CA (US)

(21) Appl. No.: 17/183,791

(22) Filed: Feb. 24, 2021

Related U.S. Application Data
(63) Continuation of application No. 17/260,950.
(60) Provisional application No. 62/518,719, filed on Jun. 13, 2017.

(51) Int. Cl. C22C 37/06; B23K 35/30; C23C 24/00

(52) U.S. Cl. CPC C22C 37/06; C23C 24/00; B23K 35/3086

(57) ABSTRACT

Disclosed herein are embodiments of a non-magnetic iron-based alloy. The alloy can contain high hard phase fractions providing for significant toughness and wear resistance. The alloy can have high austenite content and high toughness in some embodiments. Further, embodiments of the alloy can include a number of large or extremely hard particles.

### INCORPORATION BY REFERENCE TO ANY PRIORITY APPLICATIONS

This application claims from the benefit of U.S. Provisional Application No. 62/518,719, filed Jun. 13, 2017, titled “HIGH CARBIDE FRACTION NON-MAGNETIC ALLOYS FOR WEAR PLATE,” the entirety of which is incorporated herein by reference.

### BACKGROUND

### Field

Embodiments of the disclosure relate generally to non-magnetic iron alloys having high hard phase fractions.

### Description of the Related Art

Abrasive and erosive wear is a major concern for operators in applications that involve sand, rock, or other hard media wearing away against a surface. Applications which see severe wear typically utilize materials of high hardness to resist material failure due to the severe wear. These materials typically contain carbides and/or borides as hard precipitates which resist abrasion and increase the bulk hardness of the material. These materials are often applied as a coating, known as hardfacing, through various welding processes or cast directly into a part. In many applications, the impact caused by falling rocks or debris can cause the spalling of many wear resistant overlays rendering them useless. Wear resistance and impact resistance tend to be two competing properties of an alloy, because as the volume fraction of hard precipitates increases, the toughness of the alloy tends to decrease.

### SUMMARY

The present disclosure includes, but is not limited to, embodiments of alloys, including powders, wear-resistant materials and coatings, and methods of manufacturing and utilizing the same.

Disclosed herein are embodiments of an iron-based alloy configured to form a matrix which can comprise at least 90% austenite, at least 15 volume % of extremely hard particles, at least 5 volume % of large extremely hard particles, and an FCC-BCC transition temperature at or below 1000K.

In some embodiments, the alloy can be configured to form a material comprising a relative magnetic permeability of 1.04μ or less. In some embodiments, the alloy can be configured to form a material comprising an ASTM G65 abrasion loss of less than 1.5 grams, and an impact resistance of more than 6,000 20J impacts.

In some embodiments, the matrix can comprise a hypereutectic hard phase mole fraction greater or equal to 1%. In some embodiments, the matrix can comprise a total hard phase of 15 mole % or greater. In some embodiments, the matrix can comprise at least 95% austenite. In some embodiments, nickel and chromium equivalents of the matrix at 1300K can land in an austenite zone on a Schaeffler diagram.

In some embodiments, the alloy can comprise Fe, C, Cr, and Mn. In some embodiments, the alloy can comprise Fe and about 3 to about 6 wt. % C, about 12 to about 21 wt. % Cr, and about 9 to about 17 wt. % Mn. In some embodiments, the alloy can be configured to form a coating comprising about 73.2 wt. % Fe, about 3.6 wt. % C, about 13.2 wt. % Cr, and about 10 wt. % Mn formed from a wire that comprises about 60.2 wt. % Fe, about 5.7 wt. % C, about 19.9 wt. % Cr, and about 14.2 wt. % Mn.

In some embodiments, the FCC-BCC transition temperature is at or below 950K, the matrix comprises about 100% austenite, the matrix comprises at least 35 volume % of extremely hard particles, the matrix comprises at least 25 volume % of large extremely hard particles, and the matrix comprises a hypereutectic hard phase mole fraction greater or equal to 1%, and wherein the alloy is configured to form a coating comprising a relative magnetic permeability of 1.01μ or less, an ASTM G65 abrasion loss of less than 0.30 grams, and an impact resistance of more than 10,000 20J impacts.

In some embodiments, the alloy can be a powder. In some embodiments, the alloy can be one or more wires. In some embodiments, the alloy can be a coating.

Further disclosed herein are embodiments of an iron-based feedstock configured to form a matrix which can comprise at least 90% austenite, at least 15 volume % of extremely hard particles, at least 5 volume % of large extremely hard particles, and an FCC-BCC transition temperature at or below 1000K.

In some embodiments, the feedstock can be configured to form a material comprising a relative magnetic permeability of 1.04μ or less. In some embodiments, the feedstock can be configured to form a material comprising an ASTM G65 abrasion loss of less than 1.5 grams, and an impact resistance of more than 6,000 20J impacts. In some embodiments, the feedstock can comprise a hypereutectic hard phase mole fraction greater or equal to 2%. In some embodiments, the matrix can comprise a total hard phase of 15 mole % or greater. In some embodiments, the matrix can comprise at least 95% austenite. In some embodiments, nickel and chromium equivalents of the matrix at 1300K can land in an austenite zone on a Schaeffler diagram.

In some embodiments, the feedstock can comprise Fe, C, Cr, and Mn. In some embodiments, the feedstock can comprise Fe and about 3 to about 6 wt. % C, about 12 to about 21 wt. % Cr, and about 9 to about 17 wt. % Mn. In some embodiments, the feedstock can be configured to form a coating comprising about 73.2 wt. % Fe, about 3.6 wt. % C, about 13.2 wt. % Cr, and about 10 wt. % Mn and is in the form of a wire that comprises about 60.2 wt. % Fe, about 5.7 wt. % C, about 19.9 wt. % Cr, and about 14.2 wt. % Mn.

In some embodiments, wherein the FCC-BCC transition temperature is at or below 950K, the matrix comprises about 100% austenite, the matrix comprises at least 35 volume % of extremely hard particles, the matrix comprises at least 25 volume % of large extremely hard particles, and the matrix comprises a hypereutectic hard phase mole fraction greater or equal to 1%, and wherein the feedstock is configured to form a coating comprising a relative magnetic permeability of 1.01μ or less, an ASTM G65 abrasion loss of less than 0.30 grams, and an impact resistance of more than 10,000 20J impacts.

In some embodiments, the feedstock can comprise a wire or a plurality of wires. In some embodiments, the feedstock can comprise powder. In some embodiments, the feedstock can comprise cored wire or plurality of cored wires.

Also disclosed herein are embodiments of an iron-based wear resistant coating formed from an alloy which can comprise an FCC-BCC transition temperature is at or below 1000K, at least 90% austenite, at least 15 volume % of extremely hard particles, at least 5 volume % of large extremely hard particles, and an ASTM G65 abrasion loss of less than 1.5 grams, a relative magnetic permeability of 1.04μ or less, and an impact resistance of more than 6,000 20J impacts.

In some embodiments, the alloy can comprise a hypereutectic hard phase mole fraction greater or equal to 2%. In some embodiments, the alloy can comprise a total hard phase of 15 mole % or greater. In some embodiments, the alloy can comprise at least 95% austenite.

In some embodiments, the alloy can comprise Fe, C, Cr, and Mn. In some embodiments, the alloy comprises Fe and about 3 to about 6 wt. % C, about 12 to about 21 wt. % Cr, and about 9 to about 17 wt. % Mn. In some embodiments, the alloy can comprise about 73.2 wt. % Fe, about 3.6 wt. % C, about 13.2 wt. % Cr, and about 10 wt. % Mn formed from a wire that comprises about 60.2 wt. % Fe, about 5.7 wt. % C, about 19.9 wt. % Cr, and about 14.2 wt. % Mn.

In some embodiments, the alloy can comprise an FCC-BCC transition temperature at or below 950K, about 100% austenite, at least 35 volume % of extremely hard particles, at least 25 volume % of large extremely hard particles, a hypereutectic hard phase mole fraction greater or equal to 1%, a relative magnetic permeability of 1.01μ or less, an ASTM G65 abrasion loss of less than 0.30 grams, and an impact resistance of more than 10,000 20J impacts.

Further disclosed herein are embodiments of a method of forming an iron-based wear resistant coating, the method can comprise applying an alloy to a substrate to form a coating, the alloy forming the coating comprising an FCC-BCC transition temperature at or below 1000K, at least 90% austenite, at least 15 volume % of extremely hard particles, at least 5 volume % of large extremely hard particles, an ASTM G65 abrasion loss of less than 1.5 grams, a relative magnetic permeability of 1.04μ or less, and an impact resistance of more than 6,000 20J impacts.

In some embodiments, the alloy can comprise a hypereutectic hard phase mole fraction greater or equal to 2%. In some embodiments, the alloy can comprise a total hard phase of 15 mole % or greater. In some embodiments, the alloy can comprise at least 95% austenite.

In some embodiments, the alloy can comprise Fe, C, Cr, and Mn. In some embodiments, the alloy can comprise Fe and about 3 to about 6 wt. % C, about 12 to about 21 wt. % Cr, and about 9 to about 17 wt. % Mn. In some embodiments, the alloy forming the coating can comprise about 73.2 wt. % Fe, about 3.6 wt. % C, about 13.2 wt. % Cr, and about 10 wt. % Mn, and wherein the coating is formed from a wire that comprises about 60.2 wt. % Fe, about 5.7 wt. % C, about 19.9 wt. % Cr, and about 14.2 wt. % Mn.

In some embodiments, the alloy can comprise an FCC-BCC transition temperature at or below 950K, about 100% austenite, at least 35 volume % of extremely hard particles, at least 25 volume % of large extremely hard particles, a hypereutectic hard phase mole fraction greater or equal to 1%, a relative magnetic permeability of 1.01μ or less, an ASTM G65 abrasion loss of less than 0.30 grams, and an impact resistance of more than 10,000 20J impacts.

In some embodiments, the alloy can be applied by thermal spraying. In some embodiments, the substrate can be a wear plate.

In some embodiments, a wear resistant, austenitic alloy is provided comprising a total hypereutectic hard phase fraction at 1300K of greater than or equal to 1%, wherein nickel and chromium equivalents of the alloy's matrix at 1300K land in an austenite zone on a Schaeffler diagram.

In some embodiments, the alloy can comprise Fe and, in weight percent: C: 3.6, Cr: 13.2, and Mn: 10.0. In some embodiments, the alloy can comprise Fe and, in weight percent: C: about 3 to about 6, Cr: about 12 to about 21, and Mn: about 9 to about 17.

In some embodiments, the alloy can comprise a total hypereutectic hard phase fraction at 1300K of greater than or equal to 1.5%. In some embodiments, the alloy can comprise a total hypereutectic hard phase fraction at 1300K of greater than or equal to 2%. In some embodiments, the alloy can comprise a FCC-BCC transition temperature that is at or below 1000K. In some embodiments, the matrix can comprise a total hard phase of 15 mole % or greater.

Also disclosed herein are embodiments of a wear resistant, austenitic alloy having a matrix comprising a volume fraction of large extremely hard phases greater than 5%, wherein the matrix is at least 90% austenitic.

In some embodiments, the alloy can comprise Fe and, in weight percent: C: 3.6, Cr: 13.2, and Mn: 10.0. In some embodiments, the alloy can comprise Fe and, in weight percent: C: about 3 to about 6, Cr: about 12 to about 21, and Mn: about 9 to about 17.

In some embodiments, the matrix can comprise a volume fraction of large extremely hard phases greater than 10%. In some embodiments, the matrix can comprise a volume fraction of large extremely hard phases greater than 15%. In some embodiments, the matrix can be at least 95% austenitic. In some embodiments, the matrix can be at least 99% austenitic.

Also disclosed herein are embodiments of a wear resistant, austenitic alloy comprising an impact toughness configured to survive 6,000 20J impacts without failing, and an ASTM G65A abrasion loss of less than 1.5 grams.

In some embodiments, the alloy can comprise Fe and, in weight percent: C: 3.6, Cr: 13.2 and Mn: 10.0. In some embodiments, the alloy can comprise Fe and, in weight percent: C: about 3 to about 6, Cr: about 12 to about 21, and Mn: about 9 to about 17.

In some embodiments, the alloy can survive 7,000 20J impacts without failing. In some embodiments, the alloy can survive 8,000 20J impacts without failing. In some embodiments, the alloy can have an ASTM G65A abrasion loss of less than 1.25 grams. In some embodiments, the alloy can have an ASTM G65A abrasion loss of less than 1.1 grams.

Also disclosed herein are embodiments of a wear resistant iron-based alloy, the alloy comprising a matrix comprising at least 90% austenite, at least 15 volume % of extremely hard particles, at least 5 volume % of large extremely hard particles, an FCC-BCC transition temperature at or below 1000K, at least 15 mole % of the extremely hard particles, and a hypereutectic hard phase mole fraction greater or equal to 1%, wherein a coating formed by the alloy comprises an ASTM G65 abrasion loss of less than 1.5 grams, a relative magnetic permeability of 1.04μ or less, and an impact resistance of more than 6,000 20J impacts.

### BRIEF DESCRIPTION OF THE DRAWINGS

FIG. 1 illustrates an embodiment of a Schaeffler diagram when the nickel and chromium equivalent of the matrix is plotted.

FIG. 2 illustrates the phase diagram for an embodiment of the disclosure demonstrating the thermodynamic criteria for a composition of Fe: 70.8, C: 4.2, Cr: 14.2, and Mn. 10.8 wt. %.

FIG. 3 illustrates a SEM micrograph for an embodiment of the disclosure demonstrating the microstructural criteria for a composition of Fe: 70.8, C: 4.2, Cr: 14.2, and Mn. 10.8 wt. %.

### DETAILED DESCRIPTION

Embodiments of the present disclosure include, but are not limited to, hardfacing/hardbanding materials, alloys, or powder compositions used to make such hardfacing/hardbanding materials, methods of forming the hardfacing/hardbanding materials, and the components or substrates incorporating or protected by these hardfacing/hardbanding materials.

As disclosed herein, the term alloy can refer to the chemical composition forming the powder disclosed within, the powder itself, the feedstock itself, the wire, the wire including a powder, the composition of the metal component formed by the heating and/or deposition of the powder, or other methodology, and the metal component.

In some embodiments, alloys manufactured into a solid or cored wire (a sheath containing a powder) for welding or for use as a feedstock for another process may be described by specific chemistries herein. For example, the wires can be used for a thermal spray. Further, the compositions disclosed below can be from a single wire or a combination of multiple wires (such as 2, 3, 4, or 5 wires).

Branagan (U.S. Pat. Pub. No. 20070029295A1), hereby incorporated by reference in its entirety, claims “a composition comprising 35 to 65 at % of a base metal comprising iron and manganese; 10 to 50 at % of an interstitial element selected from boron, carbon, silicon or combinations thereof; 3 to 30 at % of a transition metal selected from chromium, molybdenum, tungsten or combinations thereof; and 1 to 15 at % niobium; wherein said composition forms a ductile matrix of α-Fe and/or γ-Fe including phases of complex boride, complex carbides or borocarbides.” Alloys according to some embodiments of this disclosure do not require the inclusion of niobium, and therefore some embodiments have no niobium or substantially no niobium. In some embodiments, trace amounts of niobium could be found in the disclosed alloys, such as impurities.

### Metal Alloy Compositions

In some embodiments, alloys can be described by particular alloy compositions. Embodiments of chemistries of alloys within this disclosure are shown in Table 1. Due to some variations in chemical compositions, it will be understood that all values recited in the tables are both the values listed as well as “about” the values listed. In some embodiments, the alloy can have Fe, C, Cr, and Mn. In some embodiments, the alloy may only have Fe, C, Cr, and Mn. In some embodiments, the X alloys are the coating composition and the W alloys are feedstocks, such as wire/powder compositions. In some embodiments, the wire can be solid wire or a cored wire (e.g., a sheath filled with a powder). In some embodiments the feedstock can be just the powder.

TABLE 1
Alloys Compositions of the Hardfacing and/or Feedstock

| Alloy | Fe | C | Cr | Mn |
|---|---|---|---|---|
| X12 | 70.6 | 3.4 | 14.0 | 12.0 |
| X13 | 71.2 | 2.8 | 14.0 | 12.0 |
| X14 | 73.2 | 3.6 | 13.2 | 10.0 |
| X15 | 73.2 | 2.8 | 12.0 | 12.0 |
| X16 | 71.5 | 2.5 | 14.0 | 12.0 |
| X17 | 72.0 | 2.0 | 14.0 | 12.0 |
| X18 | 70.8 | 4.2 | 14.2 | 10.8 |
| W1 | 62.0 | 4.9 | 17.1 | 16.0 |
| W2 | 62.9 | 4.6 | 18.2 | 14.3 |
| W3 | 63.6 | 4.3 | 17.1 | 15.0 |
| W4 | 61.0 | 5.0 | 18.3 | 15.7 |
| W5 | 60.7 | 4.7 | 18.2 | 16.4 |
| W6 | 60.2 | 5.7 | 19.9 | 14.2 |
| W7 | 58.8 | 5.2 | 20.3 | 15.7 |

In some embodiments, the alloy, such as in the form of hardfacing or other metallic component, can comprise, in wt. %:

Fe: 70.6-73.2 (or about 70.6 to about 73.2)

C: 2-3.6 (or about 2 to about 3.6)

Cr: 12-14 (or about 12 to about 14)

Mn: 10-12 (or about 10 to about 12).

In some embodiments, the above composition can be a feedstock, such as a powder, a cored wire, or a solid wire.

In some embodiments, the alloy, such as in the form of hardfacing or other metallic component, can comprise, in wt. %:

Fe: 70.6-73.2 (or about 70.6 to about 73.2)

C: 2-4.2 (or about 2 to about 4.2)

Cr: 12-14.2 (or about 12 to about 14.2)

Mn: 10-12 (or about 10 to about 12).

In some embodiments, the above composition can be a feedstock, such as a powder, a cored wire, or a solid wire.

In some embodiments, the alloy, such as in the form of hardfacing or other metallic component, can comprise, in wt. %:

C: 3-4 (or about 3 to about 4)

Cr: 12-14 (or about 12 to about 14)

Mn: 9-12 (or about 9 to about 12)

Fe: balance.

In some embodiments, the above composition can be a feedstock, such as a powder, a cored wire, or a solid wire.

In some embodiments, the alloy, such as in the form of hardfacing or other metallic component, can comprise, in wt. %:

C: 3-4.5 (or about 3 to about 4.5)

Cr: 12-14.5 (or about 12 to about 14.5)

Mn: 9-12 (or about 9 to about 12)

Fe: balance.

In some embodiments, the above composition can be a feedstock, such as a powder, a cored wire, or a solid wire.

In some embodiments, the alloy, such as in the form of hardfacing or other metallic component, can comprise, in wt. %, Fe and:

C: 3-4 (or about 3 to about 4)

Cr: 12-14 (or about 12 to about 14)

Mn: 9-12 (or about 9 to about 12).

In some embodiments, the above composition can be a feedstock, such as a powder, a cored wire, or a solid wire.

In some embodiments, the alloy, such as in the form of hardfacing or other metallic component or in the form of a feedstock such as a powder, a cored wire, or a solid wire, can comprise, in wt. %, Fe and:

C: 3-6 (or about 3 to about 6)

Cr: 12-21 (or about 12 to about 21)

Mn: 9-17 (or about 9 to about 17).

In some embodiments, the alloy, such as in the form of hardfacing or other metallic component, can comprise, in wt. %:

C: 3.6 (or about 3.6)

Cr: 13.2 (or about 13.2)

Mn: 10 (or about 10)

Fe: balance.

In some embodiments, the above composition can be a feedstock, such as a powder, a cored wire, or a solid wire.

In some embodiments, the alloy, such as in the form of hardfacing or other metallic component, can comprise, in wt. %:

C: 4.2 (or about 4.2)

Cr: 14.2 (or about 14.2)

Mn: 10.8 (or about 10.8)

Fe: balance.

In some embodiments, the above composition can be a feedstock, such as a powder, a cored wire, or a solid wire.

In some embodiments, the alloy, such as in the form of hardfacing or other metallic component, can comprise, in wt. %, Fe and:

C: 3.6 (or about 3.6)

Cr: 13.2 (or about 13.2)

Mn: 10 (or about 10).

In some embodiments, the above composition can be a feedstock, such as a powder, a cored wire, or a solid wire.

In some embodiments, the alloy, such as in the form of hardfacing or other metallic component, can comprise, in wt. %, Fe and:

C: 4.2 (or about 4.2)

Cr: 14.2 (or about 14.2)

Mn: 10.8 (or about 10.8).

In some embodiments, the above composition can be a feedstock, such as a powder, a cored wire, or a solid wire.

In some embodiments, the alloy, such as in the form of be a feedstock, such as a powder, a cored wire, or a solid wire, can comprise, in wt. %, Fe and:

C: 4.3-5.7 (or about 4.3-about 5.7)

Cr: 17.1-20.3 (or about 17.1-about 20.3)

Mn: 14.2-16.4 (or about 14.2-about 16.4).

In some embodiments, the above composition can be in the form of hardfacing or other metallic component.

In some embodiments, the alloy, such as in the form of hardfacing or other metallic component or in the form of a feedstock such as a powder, a cored wire, or a solid wire, can comprise, in wt. %, Fe and:

C: 3-6 (or about 3-about 6)

Cr: 12-21 (or about 12-about 21)

Mn: 9-17 (or about 9-17).

In some embodiments, other elements can be added as well and the Fe can be the balance. In some embodiments, the alloys do not contain niobium. In some embodiments, the alloys only contain trace amounts of niobium.

In some embodiments, the disclosed compositions can be the wire/powder, the coating or other metallic component, or both.

The disclosed alloys can incorporate the above elemental constituents to a total of 100 wt. %. In some embodiments, the alloy may include, may be limited to, or may consist essentially of the above named elements. In some embodiments, the alloy may include 2% or less of impurities, such as niobium. Impurities may be understood as elements or compositions that may be included in the alloys due to inclusion in the feedstock components, through introduction in the manufacturing process.

Further, the Fe content identified in all of the compositions described in the above paragraphs may be the balance of the composition as indicated above, or alternatively, the balance of the composition may comprise Fe and other elements. In some embodiments, the balance may consist essentially of Fe and may include incidental impurities. In some embodiments, the compositions can have at least 60 wt. % Fe (or at least about 60 wt. % Fe). In some embodiments, the composition can have between 60 and 80 wt. % Fe (or between about 60 and about 80 wt. % Fe). In some embodiments, the composition can have between 60 and 75 wt. % Fe (or between about 60 and about 75 wt. % Fe).

### Description of Alloying Additions

In this disclosure, certain specific alloying additions may be used to meet the various thermodynamic and microstructural criteria described below. The alloy additions described are intended to be non-limiting and serve as examples.

Carbon may be added for two primary reasons: 1) carbon promotes the formation of an austenitic matrix; and/or 2) carbon can combine with transition metals to form carbides which improve wear performance.

Vanadium, titanium, niobium, zirconium, hafnium, tantalum, and tungsten, choosing any one or more of the listed elements, may be added to the alloy in addition to carbon. In some embodiments, niobium is not used. These elements can combine with carbon to form MC type carbides which form an isolated morphology and are extremely hard (e.g., having a hardness greater than 1000HV) resulting in tough wear resistant alloys. In contrast, other carbides, such as those formed by iron and/or chromium, do not form an isolated morphology and are considerably softer than the MC type described above. The MC type carbides also form at a sufficiently high temperature (e.g., at a temperature higher than the formation temperature of the matrix) that control over the amount of carbon in the liquid during solidification is possible over a wide range of solidification conditions. In some embodiments, the alloy can have low enough carbon levels to prevent the formation of embrittling phases. This can allow for the elimination of embrittling borocarbide phases and further control over the performance of the alloy. In some embodiments, no borocarbides form.

In some embodiments of this disclosure, vanadium may be used as a carbide former preferentially compared to titanium, niobium, zirconium, hafnium, tantalum, and/or tungsten. This allows improved fluidity of the liquid alloy at high temperature as MC type carbides containing mostly vanadium tend to form at a lower temperature improving viscosity. This can allow for easier atomization of the alloy into a powder, improved bead morphology during welding, and easier casting.

Manganese may be added to the alloy to modify the FCC-BCC transition temperature to allow for the formation of austenite and therefore increasing the toughness of the alloy. For example, manganese can be an austenitic stabilizer and can reduce the FCC-BCC transition temperature.

Silicon, manganese, aluminum, and/or titanium have deoxidizing effects on the alloy which improves performance and avoids porosity when utilized in various processes where oxygen is present.

Nickel, silicon, manganese, vanadium, molybdenum, boron, carbon, and copper all can improve the hardenability of the alloy by increasing the carbon equivalent of the matrix.

### Thermodynamic Criteria

Embodiments of alloys of the disclosure can be fully described by certain equilibrium thermodynamic criteria. The alloys can meet some, or all, of the described thermodynamic criteria.

The first thermodynamic criterion is related to the FCC-BCC transition temperature of the ferrous matrix in the alloys. The FCC-BCC transition temperature is defined as the temperature where the mole fraction of the FCC phase (austenite) begins to drop with decreasing temperature, and the mole fraction of the BCC phase (ferrite) is now greater than 0 mole %. The FCC-BCC transition temperature is an indicator of the final phase of the alloy's matrix.

In some embodiments, the FCC-BCC transition temperature can be at or below 1000K (or at or below about 1000K). In some embodiments, the FCC-BCC transition temperature can be at or below 950K (or at or below about 950K). In some embodiments, the FCC-BCC transition temperature is at or below 900K (or at or below about 900K).

The second thermodynamic criterion is related to the total concentration of extremely hard particles in the microstructure. As the mole fraction of extremely hard particles is increased, the bulk hardness of the alloy increases, thus the wear resistance will also increase and thus can be desirable for hardfacing applications. For the purposes of this disclosure, extremely hard particles are defined as phases that exhibit a hardness of 1000 Vickers or greater (or about 1000 Vickers or greater). The total concentration of extremely hard particles is defined as the total mole % of all phases which meets or exceeds a hardness of 1000 Vickers which is thermodynamically stable at 1300K in the alloy.

In some embodiments, the extremely hard particle fraction can be 15 mole % or greater (or about 15 mole % or greater). In some embodiments, the extremely hard particle fraction can be 20 mole % or greater (or about 20 mole % or greater). In some embodiments, the extremely hard particle fraction can be 25 mole % or greater (or about 25 mole % or greater).

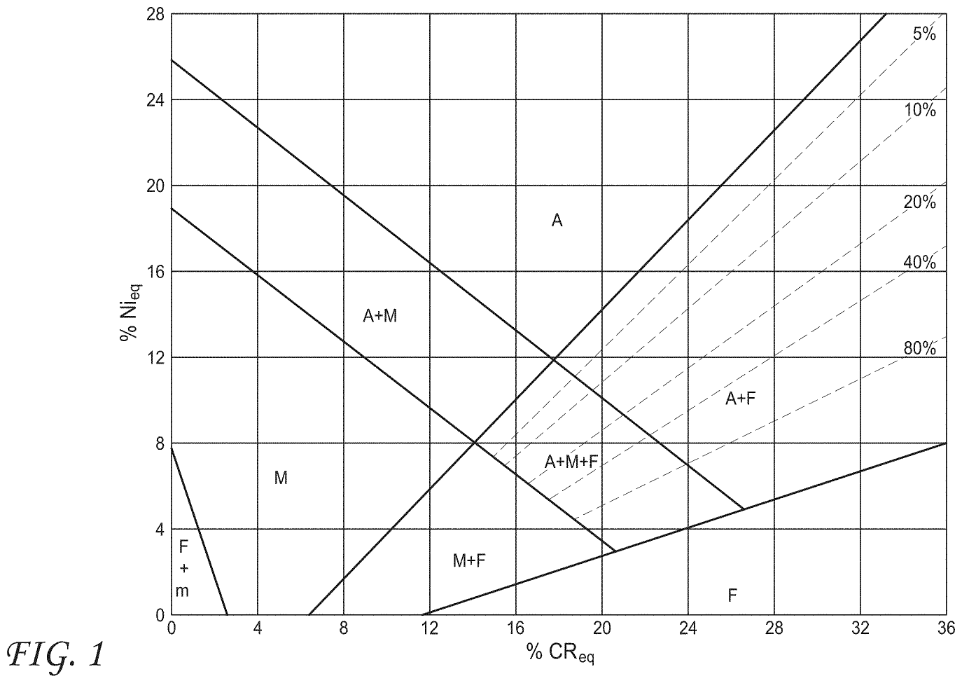

The third thermodynamic criterion is the location of the alloy on a Schaeffler diagram when the nickel and chromium equivalent of the matrix is plotted as in FIG. 1. Chromium equivalent is calculated using the following equation with each element in wt %: Cr_{eq}=Cr+Mo+(⅕*Si)+(0.5*Nb). Nickel equivalent is calculated using the following equation with each element in wt %: Ni_{eq}=Ni+(30*C)+(0.5*Mn). The wt % of each element in the matrix at 1300K (or about 1300K) is used to calculate the Chromium and Nickel equivalents.

In some embodiments, the nickel and chromium equivalent of the alloy's matrix at 1300K lands in the austenite region when plotted on the Schaeffler diagram. Thus, the alloy will fall in the “A” region shown in FIG. 1. If the alloy fell in another region, such as “A+M” or “A+F”, the alloy would not be fully austenitic.

The fourth thermodynamic criterion relates to the amount of hypereutectic hard phases that form in the alloy. A hypereutectic hard phase is a hard phase (e.g., a carbide or a boride) that begins to form at a temperature higher than the eutectic point of the alloy. The eutectic point of these alloys is the temperature at which the austenitic (FCC) matrix begins to form.

In some embodiments, the mole fraction of hypereutectic hard phases can be greater than or equal to 1% (or greater than or equal to about 1%). In some embodiments, the mole fraction of hypereutectic hard phases can be greater than or equal to 1.5% (or greater than or equal to about 1.5%). In some embodiments, the mole fraction of hypereutectic hard phases can be greater than or equal to 2% (or greater than or equal to about 2%).

In some embodiments, the matrix can comprise a total hard phase of 15 mole % or greater. In some embodiments, the matrix can comprise a total hard phase of 20 mole % or greater. In some embodiments, the matrix can comprise a total hard phase of 25 mole % or greater. In some embodiments, the matrix can comprise a total hard phase of 30 mole % or greater. In some embodiments, the matrix can comprise a total hard phase of 35 mole % or greater.

Table 2 lists the thermodynamic criteria of two of the alloys of Table 1.

TABLE 2
Thermodynamic Criteria

| | | Total Hard | | Hypereutectic |
|---|---|---|---|---|
| | Trans | Phase | Schaeffler | Hard Phase |
| Alloy | FCC-BCC | Fraction | Diagram | Fraction |
| X14 | 950K | 38.2% | Austenite | 2.75% |
| X18 | 900K | 45.2% | Austenite | 8.05% |

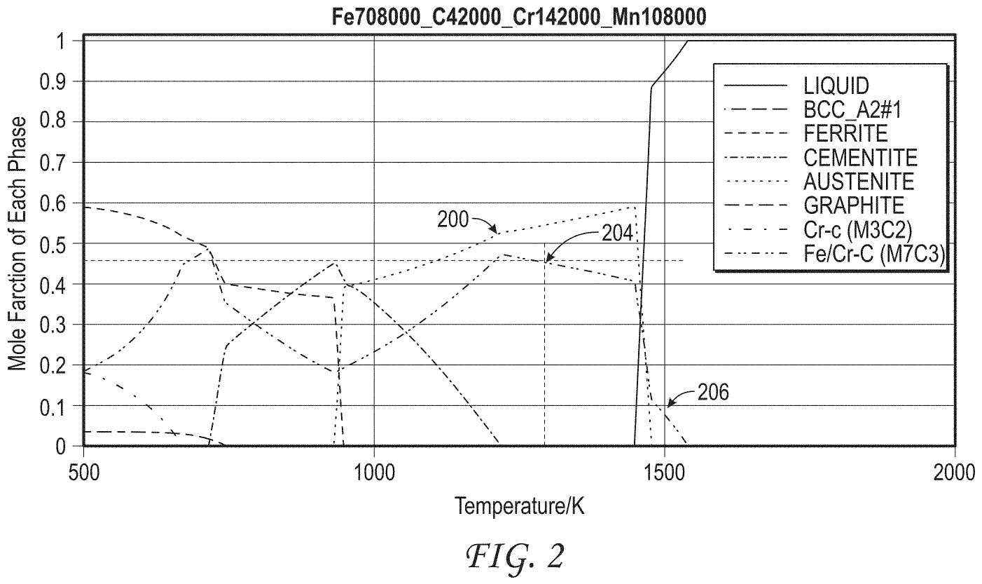

FIG. 2 illustrates a thermodynamic diagram of alloy X18. As shown, the alloy has a fully austenitic matrix 202, about 47% mole fraction of extremely hard phases 204, and about 10% mole fraction of large, defined below, extremely hard phases 206.

### Microstructural Criteria

In some embodiments, the alloys are fully described by microstructural criterion. The alloys can meet some, or all, of the described microstructural criteria.

The first microstructural criterion is related to the Fe-based matrix phase being predominantly austenitic, the non-magnetic form of iron or steel. Ferrite and martensite are the two most common and likely forms of the matrix phase in this alloy space. Both are highly magnetic and will prevent the hardfacing alloy from meeting the magnetic performance requirements if present in sufficient quantities. Further, while ferrite and martensite can be harder and more wear-resistant than austenite, they often lack ductility and toughness. By utilizing a fully austenitic matrix, one can use a high volume fraction of hard phases to achieve a combination of high wear resistance and toughness in the hardfacing alloy.

In some embodiments, the matrix can be at least 90% austenite (or at least about 90% austenite). In some embodiments, the matrix can be at least 95% austenite (or at least about 95% austenite). In some embodiments, the matrix can be at least 99% austenite (or at least about 99% austenite).

The second microstructural criterion is related to the total measured volume fraction of extremely hard particles. In some embodiments, the alloy can possess at least 15 volume % (or at least about 15 volume %) of extremely hard particles. In some embodiments, the alloy can possess 20 volume % (or at least about 20 volume %) of extremely hard particles. In some embodiments, the alloy can possess 25 volume % (or at least about 25 volume %) of extremely hard particles.

The third microstructural criterion is related to the size of the extremely hard particles present in the alloy. A large extremely hard particle is defined as an extremely hard particle that is larger than 25 μm (or larger than about 25 μm) in any one direction. In some embodiments, the volume fraction of large extremely hard phases can be greater than or equal to 5% (or greater than or equal to about 5%). In some embodiments, the volume fraction of large extremely hard phases can be greater than or equal to 10% (or greater than or equal to about 10%). In some embodiments, the volume fraction of large extremely hard phases can be greater than or equal to 15% (or greater than or equal to about 15%).

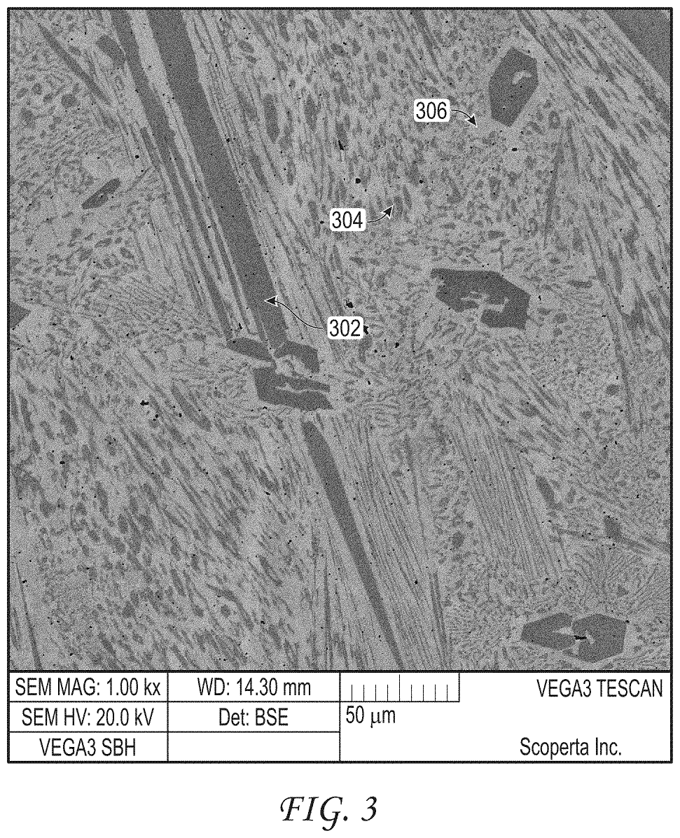

FIG. 3 illustrates the microstructure of an example embodiment of alloy X18. As shown, the alloy has a fully austenitic matrix 302, about 40 volume % of extremely hard particles 304 and about 10 volume % of large extremely hard particles 306.

Cheney teaches in U.S. Pat. Pub. No. 2015/0275341, hereby incorporated by reference in its entirety, that fine sized hard phases benefit the performance of the austenitic alloy, whereas this disclosure demonstrates the usefulness of coarser (e.g., larger) hard phases.

### Powder Manufacture

It is often advantageous to manufacture an alloy into a powder (and in some embodiments into a wire) as an intermediary step in producing a bulk product or applying a coating to a substrate. Powder can be manufactured via atomization or other manufacturing methods. The feasibility of such a process for a particular alloy is often a function of the alloy's solidification behavior, and thus its thermodynamic characteristics.

To make a production of powder for processes such as plasma transferred arc (PTA), high velocity oxygen fuel spraying (HVOF), laser welding, and other powder metallurgy processes, it can be advantageous to be able to manufacture the powder at high yields in the size range specified above. The manufacturing process can include forming a melt of the alloy, forcing the melt through a nozzle to form a stream of material, and spraying water or air at the produced stream of the melt to solidify it into a powder form. The powder is then sifted to eliminate any particles that do not meet the specific size requirements.

Embodiments of the disclosed alloys can be produced as powders in high yields to be used in such processes. On the other hand, many alloys, such as those described in U.S. Pub. No. 2013/0294962, hereby incorporated by reference in its entirety, and other common wear resistant materials, would have low yields due to their properties, such as their thermodynamic properties, when atomized into a powder. Thus, they would not be suitable for powder manufacture.

### Performance

Wear resistant alloys are often described by their performance in laboratory testing. The disclosed tests correlate well with wear resistant components in service. In some embodiments, the alloy can be formed as a hardfacing alloy layer for performance purposes.

In some embodiments, the hardfacing alloy layer can have an ASTM G65 abrasion loss less than 1.5 grams (or less than about 1.5 grams). In some embodiments, the hardfacing alloy layer can have an ASTM G65 abrasion loss of less than 1.25 grams (or less than about 1.25 grams). In some embodiments, the hardfacing alloy layer can have an ASTM G65 abrasion loss of less than 1.1 grams (or less than about 1.1 grams). In some embodiments, the hardfacing alloy layer can have an ASTM G65 abrasion loss of less than 0.5 grams (or less than about 0.5 grams). In some embodiments, the hardfacing alloy layer can have an ASTM G65 abrasion loss of less than 0.3 grams (or less than about 0.3 grams).

To determine the magnetism of a specific alloy, a magnetic permeability test is performed using, for example, a Severn Gauge or other similar pieces of equipment.

In some embodiments, the hardfacing alloy can have a relative magnetic permeability of 1.04μ or less (or about 1.04μ or less). In some embodiments, the hardfacing alloy can have a relative magnetic permeability of 1.03μ or less (or about 1.03μ or less). In some embodiments, the hardfacing alloy can have a relative magnetic permeability of 1.02μ or less (or about 1.02μ or less). In some embodiments, the hardfacing alloy can have a relative magnetic permeability of 1.01μ or less (or about 1.01μ or less).

Another advantageous performance characteristic is the impact resistance of the alloys. To measure the impact resistance of the alloys, a 6 mm welded sample is repeatedly impacted with 20J of energy until the weld fails. Failure is described as when more than 1 g of weld has chipped or spalled from the sample. The impact resistance is described in this context as the number of impacts until said failure.

In some embodiments, the hardfacing alloy can last more than 6,000 (or more than about 6,000) 20J impacts until failure. In some embodiments, the hardfacing alloy can last more than 7,000 (or more than about 7,000) 20J impacts until failure. In some embodiments, the hardfacing alloy can last more than 8,000 (or more than about 8,000) 20J impacts until failure. In some embodiments, the hardfacing alloy can last more than 10,000 (or more than about 10,000) 20J impacts until failure. In some embodiments, the hardfacing alloy can last more than 13,000 (or more than about 13,000) 20J impacts until failure.

### EXAMPLES

The following examples are intended to be illustrative and non-limiting. The compositions and data are shown in Table 3.

Alloys A1-A9 were discovered using computational metallurgy techniques and meet the thermodynamic, microstructural and performance criteria disclosed herein. The alloys were manufactured using a cored wire manufacturing process to produce a flux cored wire to be used as feedstock in an open-arc welding process. The hardfacing layers were characterized according to the performance criteria in this disclosure and most notably all possessed a magnetic permeability of less than (<) 1.02μ and are thus considered to be non-magnetic.

Alloys V1-V49 may fall within the chemistry ranges described in this disclosure and may demonstrate some but not all criteria described in this disclosure. Most notably, all of these alloys possess a magnetic permeability greater than (>) 1.03μ and are thus considered to be magnetic alloys.

Alloy M1 is a commercially sold product that may fall within the chemistry ranges described in this disclosure and possesses magnetic permeability of less than (<) 1.02μ and is thus considered non-magnetic. However, this alloy does not meet the performance requirements discussed herein as the measured ASTM G65A mass loss is greater than 1.5 grams.

Alloy M2 is commercially sold product from ESAB called Stoody 103CP and is described as an alloy with “Primary chromium carbides in an austenitic matrix”. Although this description and the chemistry may fall within the ranges described in this disclosure, this alloy does not teach our technology as it is also described by the manufacturer as “magnetic”.

TABLE 3
Example Alloys and Performance Criteria

| | | | | | | | | | | | | | G65A | | |
|---|---|---|---|---|---|---|---|---|---|---|---|---|---|---|---|
| | | | | | | | | | | | | | Mass | Magnetic | Impact |
| Alloy | B | C | Cr | Mn | Mo | Nb | Ni | Si | V | Ti | W | Fe | Loss | Permeability | Resistance |
| A1 | 0 | 3.9 | 13 | 10.6 | 0 | 0 | 0 | 0 | 0 | 0 | 0 | 72.5 | 0.20 g | <1.02 μm | 10,000 |
| A2 | 0 | 3.3 | 12.8 | 10 | 0 | 0 | 0 | 0 | 0 | 0 | 0 | 73.9 | 0.41 g | <1.02 μm | |
| A3 | 0 | 3.6 | 13.5 | 10.4 | 0 | 0 | 0 | 0 | 0 | 0 | 0 | 72.5 | 0.32 g | <1.02 μm | |
| A4 | 0 | 3.6 | 13.2 | 10 | 0 | 0 | 0 | 0 | 0 | 0 | 0 | 73.2 | 0.16 g | <1.02 μm | 13,000 |
| A5 | 0 | 3.9 | 13 | 10.6 | 0 | 0 | 0 | 0 | 0 | 0 | 0 | 72.5 | 0.22 g | <1.02 μm | |
| A6 | 0 | 3.5 | 12.9 | 10.4 | 0 | 0 | 0 | 0 | 0 | 0 | 0 | 73.2 | 0.38 g | <1.02 μm | |
| A7 | 0 | 3.5 | 12.6 | 10.2 | 0 | 0 | 0 | 0 | 0 | 0 | 0 | 73.7 | 0.38 g | <1.02 μm | |
| A8 | 0 | 3.7 | 14.1 | 11.4 | 0 | 0 | 0 | 0 | 0 | 0 | 0 | 70.8 | 0.20 g | <1.02 μm | |
| A9 | 0 | 3.7 | 14.8 | 12.3 | 0 | 0 | 0 | 0 | 0 | 0 | 0 | 69.2 | 0.20 g | <1.02 μm | |
| V1 | 0 | 2.6 | 28 | 0 | 0 | 3 | 0 | 0 | 0 | 0 | 5 | 61.4 | | >1.03 μm | |
| V2 | 0 | 2 | 28 | 0 | 0 | 3 | 0 | 0 | 0 | 0 | 5 | 62 | | >1.03 μm | |
| V3 | 0 | 2 | 28 | 0 | 0 | 1.5 | 0 | 0 | 0 | 0 | 5 | 63.5 | | >1.03 μm | |
| V4 | 1 | 0.5 | 15 | 0 | 0 | 2 | 0 | 0 | 0 | 0 | 5 | 76.5 | | >1.03 μm | |
| V5 | 0.6 | 0.7 | 15 | 0 | 0 | 0 | 0 | 0 | 0 | 0 | 5 | 78.7 | | >1.03 μm | |
| V6 | 0.8 | 1 | 15 | 0 | 0 | 2 | 0 | 0 | 0 | 0 | 5 | 76.2 | | >1.03 μm | |
| V7 | 0.7 | 1 | 15 | 0 | 0 | 0 | 0 | 0 | 0 | 0 | 5 | 78.3 | | >1.03 μm | |
| V8 | 1 | 1.2 | 15 | 0 | 0 | 2 | 0 | 0 | 0 | 0 | 5 | 75.8 | | >1.03 μm | |
| V9 | 1 | 1.2 | 15 | 0 | 0 | 0 | 0 | 0 | 0 | 0 | 5 | 77.8 | | >1.03 μm | |
| V10 | 1.5 | 0.5 | 3 | 1 | 0 | 5 | 0 | 1 | 0 | 0.5 | 10.7 | 76.8 | | >1.03 μm | |
| V11 | 1.5 | 1.5 | 3 | 1 | 0 | 5 | 0 | 1 | 0 | 0.5 | 10.7 | 75.8 | | >1.03 μm | |
| V12 | 1.5 | 1 | 3 | 1 | 0 | 5 | 0 | 1 | 0 | 0.5 | 10.7 | 76.3 | | >1.03 μm | |
| V13 | 1.5 | 1 | 3 | 1 | 0 | 5 | 0 | 1 | 0 | 0.5 | 10.7 | 76.3 | | >1.03 μm | |
| V14 | 1 | 0.5 | 15 | 0 | 0 | 1 | 0 | 0 | 0 | 0 | 5 | 77.5 | | >1.03 μm | |
| V15 | 0.5 | 0.8 | 15 | 0 | 0 | 0 | 0 | 0 | 0 | 0 | 5 | 78.7 | | >1.03 μm | |
| V16 | 2 | 0.5 | 5 | 0 | 0 | 2 | 0 | 0 | 0 | 0 | 4 | 86.5 | | >1.03 μm | |
| V17 | 1.5 | 0.5 | 7 | 0 | 0 | 2 | 0 | 0 | 0 | 0 | 4 | 85 | | >1.03 μm | |
| V18 | 2.5 | 0.5 | 5 | 0 | 0 | 2 | 0 | 0 | 0 | 0 | 6 | 84 | | >1.03 μm | |
| V19 | 0 | 5 | 1.5 | 1 | 1 | 0 | 0 | 4 | 0 | 0 | 32 | 55.5 | | >1.03 μm | |
| V20 | 0 | 3.5 | 1.5 | 1 | 1 | 0 | 0 | 2 | 0 | 0 | 32 | 59 | | >1.03 μm | |
| V21 | 0 | 1.5 | 1.5 | 1 | 1 | 0 | 0 | 1 | 0 | 0 | 32 | 62 | | >1.03 μm | |
| V22 | 0 | 3 | 1.5 | 1 | 1 | 0 | 0 | 3 | 0 | 0 | 36 | 54.5 | | >1.03 μm | |
| V23 | 0 | 1.5 | 1.5 | 1 | 1 | 0 | 0 | 2 | 0 | 0 | 16 | 77 | | >1.03 μm | |
| V24 | 0 | 1 | 1.5 | 1 | 1 | 0 | 0 | 1 | 0 | 0 | 26 | 68.5 | | >1.03 μm | |
| V25 | 1.05 | 1.29 | 4.76 | 0 | 0 | 4.94 | 0 | 0.46 | 0 | 0.5 | 9.94 | 77.06 | | >1.03 μm | |
| V26 | 1.05 | 1.29 | 4.76 | 0 | 0 | 4.94 | 0 | 0.46 | 1.6 | 0.5 | 9.94 | 75.46 | | >1.03 μm | |
| V27 | 1.05 | 1.29 | 4.76 | 0 | 0 | 4.94 | 0 | 0.46 | 3 | 0.5 | 9.94 | 74.06 | | >1.03 μm | |
| V28 | 0.8 | 1 | 15 | 0 | 0 | 2 | 0 | 0 | 3 | 0 | 5 | 73.2 | | >1.03 μm | |
| V29 | 1.9 | 1.9 | 15 | 0 | 0 | 0 | 0 | 0 | 0 | 6 | 10 | 65.2 | | >1.03 μm | |
| V30 | 1.9 | 1.9 | 20 | 0 | 0 | 0 | 0 | 0 | 0 | 6 | 2 | 68.2 | | >1.03 μm | |
| V31 | 0.7 | 1.9 | 5 | 0 | 0 | 0 | 0 | 0 | 0 | 6 | 10 | 76.4 | | >1.03 μm | |
| V32 | 2.6 | 1.6 | 20 | 0 | 0 | 0 | 0 | 0 | 0 | 6 | 0 | 69.8 | | >1.03 μm | |
| V33 | 2.6 | 2 | 10 | 0 | 0 | 0 | 0 | 0 | 0 | 6 | 0 | 79.4 | | >1.03 μm | |
| V34 | 3 | 1.6 | 10 | 0 | 0 | 0 | 0 | 0 | 0 | 6 | 0 | 79.4 | | >1.03 μm | |
| V35 | 2 | 1.8 | 5 | 0 | 0 | 0 | 0 | 0 | 0 | 6 | 6 | 79.2 | | >1.03 μm | |
| V36 | 1.4 | 2.6 | 10 | 0 | 0 | 2 | 0 | 0 | 12 | 0 | 0 | 72 | | >1.03 μm | |
| V37 | 1.8 | 3 | 10 | 0 | 0 | 2 | 0 | 0 | 10 | 0 | 0 | 73.2 | | >1.03 μm | |
| V38 | 2.4 | 3 | 10 | 0 | 0 | 2 | 0 | 0 | 12 | 0 | 0 | 70.6 | | >1.03 μm | |
| V39 | 1 | 2.6 | 10 | 0 | 0 | 2 | 0 | 0 | 11 | 0 | 0 | 73.4 | | >1.03 μm | |
| V40 | 1.4 | 2.8 | 10 | 0 | 0 | 0 | 0 | 0 | 14 | 0 | 0 | 71.8 | | >1.03 μm | |
| V41 | 1.4 | 2.8 | 10 | 0 | 0 | 0 | 0 | 0 | 18 | 0 | 0 | 67.8 | | >1.03 μm | |
| V42 | 1.4 | 2.8 | 10 | 0 | 0 | 1 | 0 | 0 | 18 | 0 | 0 | 66.8 | | >1.03 μm | |
| V43 | 0 | 3 | 5 | 0 | 0 | 0 | 0 | 0 | 15 | 0 | 0 | 77 | | >1.03 μm | |
| V44 | 1 | 0.9 | 4.4 | 2 | 0 | 1.6 | 0 | 1.2 | 0.1 | 3.1 | 12 | 73.7 | | >1.03 μm | |
| V45 | 1 | 0.9 | 4.3 | 2 | 0 | 1.6 | 0 | 1.2 | 0.1 | 5 | 11.7 | 72.2 | | >1.03 μm | |
| V46 | 1 | 0.9 | 4.3 | 1.9 | 0 | 1.6 | 0 | 1.2 | 0.1 | 6.1 | 11.6 | 71.3 | | >1.03 μm | |
| V47 | 1 | 0.9 | 4.4 | 2 | 0 | 1.6 | 0 | 1.2 | 0.1 | 3.2 | 12 | 73.6 | | >1.03 μm | |
| V48 | 1 | 0.9 | 4.4 | 2 | 0 | 1.6 | 0 | 1.2 | 0.1 | 3.4 | 11.9 | 73.5 | | >1.03 μm | |
| V49 | 1 | 0.9 | 4.4 | 2 | 0 | 1.6 | 0 | 1.2 | 0.1 | 3.6 | 11.9 | 73.3 | | >1.03 μm | |
| M1 | 0 | 0.6 | 4.9 | 13 | 0 | 0 | 0.5 | 0.4 | 0 | 0 | 0 | 80.6 | 1.74 | <1.02 μm | |
| M2 | 0 | 5 | 27 | 0 | 0 | 0 | 5.5 | 0 | 0 | 0 | 0 | 62.5 | | Magnetic | |

### Applications

The alloys described in this disclosure can be used in a variety of applications and industries. Some non-limiting examples of applications of use include:

Surface Mining applications include the following components and coatings for the following components: Wear resistant sleeves and/or wear resistant hardfacing for slurry pipelines, mud pump components including pump housing or impeller or hardfacing for mud pump components, are feed chute components including chute blocks or hardfacing of chute blocks, separation screens including but not limited to rotary breaker screens, banana screens, and shaker screens, liners for autogenous grinding mills and semi-autogenous grinding mills, ground engaging tools and hardfacing for ground engaging tools, wear plate for buckets and dump truck liners, heel blocks and hardfacing for heel blocks on mining shovels, grader blades and hardfacing for grader blades, stacker reclaimers, sizer crushers, general wear packages for mining components and other comminution components.

From the foregoing description, it will be appreciated that an inventive non-magnetic alloys and methods of use are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

The invention claimed is:

1. An iron-based alloy configured to form a coating, the coating comprising:
a matrix comprising at least 90 mole % austenite;
at least 15 volume % of extremely hard particles having a hardness exceeding 1000 HV;
wherein the extremely hard particles comprise at least 5 volume % of large extremely hard particles having a dimension greater than 25 m in any direction; and
an FCC-BCC transition temperature at or below 1000K.

2. The alloy of claim 1, wherein the alloy is configured to form the coating comprising a relative magnetic permeability of 1.04μ or less.

3. The alloy of claim 1, wherein the alloy is configured to form the coating a comprising:
an ASTM G65 abrasion loss of less than 1.5 grams; and
an impact resistance of more than 6,000 20J impacts.

4. The alloy of claim 1, wherein the coating comprises a hypereutectic hard phase mole fraction greater or equal to 1%.

5. The alloy of claim 1, wherein the coating comprises a total hard phase of 15 mole % or greater.

6. The alloy of claim 1, wherein the matrix comprises at least 95 mole % 95%-austenite.

7. The alloy of claim 1, wherein the alloy comprises Fe, C, Cr, and Mn.

8. The alloy of claim 7, wherein the alloy comprises Fe and:
about 3 to about 6 wt. % C;
about 12 to about 21 wt. % Cr; and
about 9 to about 17 wt. % Mn.

9. The alloy of claim 1, wherein the alloy is configured to form the coating comprising about 3-6 wt. % C, about 12-21 wt. % Cr, and about 9-17 wt. % Mn and a balance of Fe.

10. The alloy of claim 1, wherein the alloy is configured to form the coating comprising:
the FCC-BCC transition temperature is at or below 950K;
the matrix consisting essentially of austenite;
at least 35 volume % of the extremely hard particles;
at least 25 volume % of the large extremely hard particles;
a hypereutectic hard phase mole fraction greater or equal to 1 mole %;
wherein the alloy is configured to form a coating comprising:
a relative magnetic permeability of 1.01μ or less;
an ASTM G65 abrasion loss of less than 0.30 grams; and
an impact resistance of more than 10,000 20J impacts.

11. The alloy of claim 1, wherein nickel and chromium equivalents of the matrix at 1300K land in an austenite zone on a Schaeffler diagram.

12. The alloy of claim 1, wherein the alloy is a powder.

13. The alloy of claim 1, wherein the alloy is one or more wires.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A wear resistant, austenitic alloy comprising:
Fe: at least 60% by weight;
C: about 3 to about 4% by weight;
Cr: about 12 to about 14% by weight;
Mn: about 9 to about 12% by weight;
large extremely hard phases having a hardness exceeding 1000 HV and a dimension greater than 25 m in any direction at a volume percentage greater than 5%; and
a total hypereutectic hard phase fraction at 1300K of greater than or equal to 1 mole %;
wherein nickel and chromium equivalents of the alloy's matrix at 1300K land in an austenite zone on a Schaeffler diagram.

48. (canceled)

49. (canceled)

50. The alloy of claim 47, comprising a total hypereutectic hard phase fraction at 1300K of greater than or equal to 1.5 mole %.

51. The alloy claim 47, comprising a total hypereutectic hard phase fraction at 1300K of greater than or equal to 2 mole %.

52. The alloy of claim 47, comprising a FCC-BCC transition temperature that is at or below 1000K.

53. The alloy of claim 47, wherein the matrix comprises a total hard phase of 15 mole % or greater.

54. A wear resistant, austenitic alloy having a matrix, the austenitic alloy comprising:
Fe: at least 60% by weight;
C: about 3 to about 4% by weight;
Cr: about 12 to about 14% by weight;
Mn: about 9 to about 12% by weight;
large extremely hard phases having a hardness exceeding 1000 HV and a dimension greater than 25 m in any direction at a volume percentage greater than 5%; and
wherein the matrix is at least 90 mole % austenitic.

55. (canceled)

56. (canceled)

57. The austenitic alloy of claim 54, wherein the volume percentage of large extremely hard phases is greater than 10%.

58. The austenitic alloy of claim 54, wherein the volume percentage of large extremely hard phases is greater than 15%.

59. The austenitic alloy of claim 54, wherein the matrix is at least 95% austenitic by mole percentage.

60. The austenitic alloy of claim 54, wherein the matrix is at least 99% austenitic by mole percentage.

61. A wear resistant, austenitic alloy comprising:
Fe: at least 60% by weight;
C: about 3 to about 4% by weight;
Cr: about 12 to about 14% by weight;
Mn: about 9 to about 12% by weight;
large extremely hard phases having a hardness exceeding 1000 HV and a dimension greater than 25 m in any direction at a volume percentage greater than 5%;
an impact toughness configured to survive 6,000 20J impacts without failing; and
an ASTM G65A abrasion loss of less than 1.5 grams.

62. (canceled)

63. (canceled)

64. The austenitic alloy of claim 61, wherein the alloy can survive 7,000 20J impacts without failing.

65. The austenitic alloy of claim 61, wherein the alloy can survive 8,000 20J impacts without failing.

66. The austenitic alloy of claim 61, wherein the alloy has an ASTM G65A abrasion loss of less than 1.25 grams.

67. The austenitic alloy of claim 61, wherein the alloy has an ASTM G65A abrasion loss of less than 1.1 grams.

68. (canceled)
